(19) United States
(12) Patent Application Publication
(10) Pub. No.: US 2015/0091406 A1
(43) Pub. Date: Apr. 2, 2015

(54) PERMANENT MAGNET MOTOR

(71) Applicants: Fumio Tajima, Tokyo (JP); Yoshihiro Yamaguchi, Tokyo (JP); Hiroshi Nagase, Tokyo (JP); Masataka Yahara, Tokyo (JP); Yukinari Fujisawa, Tokyo (JP)

(72) Inventors: Fumio Tajima, Tokyo (JP); Yoshihiro Yamaguchi, Tokyo (JP); Hiroshi Nagase, Tokyo (JP); Masataka Yahara, Tokyo (JP); Yukinari Fujisawa, Tokyo (JP)

(73) Assignee: AIDA ENGINEERING, LTD., Kanagawa (JP)

(21) Appl. No.: 14/388,612

(22) PCT Filed: Mar. 30, 2012
(86) PCT No.: PCT/JP2012/058656

§ 371 Date: Sep. 26, 2014

(51) Int. Cl. H02K 1/27

(52) U.S. Cl. CPC H02K 1/2773
USPC 310/156.38

(57) ABSTRACT

A permanent magnet motor includes a P-pole-implanted permanent magnet rotator containing a ferrite magnet in a laminated silicon steel sheet, wherein, at one pole, a U-shaped permanent magnet comprising three parts, and, at the outer periphery of the U-shaped magnet, one outer-periphery permanent magnet disposed longitudinally in the peripheral direction are provided to generate permanent magnet torque. At one pole, the permanent magnet rotator generates reluctance torque using two salient poles formed between the U-shaped permanent magnet and the outer-periphery permanent magnet. One central salient pole is formed between the adjacent poles. A stator comprises an M-phase stator winding that is a distributed winding, and a stator core having Ns slots. The ratio of Ns/P/M is a common fraction. When the width of the center salient pole is set to τcp and the slot pitch of the stator core is set to τs, τcp is smaller than τs.

### TECHNICAL FIELD

The present invention relates to a permanent magnet motor structure using a low-price rectangular parallelepiped ferrite magnet, which allows a permanent magnet motor mainly using reluctance torque to realize large torque and low torque ripple.

### BACKGROUND

The permanent magnet motor for generating a large torque configured to arrange high-performance neodymium magnets on the rotator surface, so called surface magnet type has been put into practical use, which is capable of realizing both high torque and low torque ripple. However, recent sharp price rise and difficulty in availability of the neodymium magnet has demanded to promote research and development of the permanent magnet motor using the ferrite magnet. The price of the ferrite magnet is lower than that of the neodymium magnet by 1/10 or less, but exhibits inferior performance both in residual magnetic flux density and coercive force to those of the neodymium magnet by ⅓ or less. It is therefore necessary for the permanent magnet motor with the ferrite magnet to use the reluctance torque in addition to the permanent magnet torque for the purpose of approximating the torque to the one generated by the neodymium magnet motor. The motor of this type is configured to implant the permanent magnet in the rotator core.

Followings are development subjects of the permanent magnet motor using the ferrite magnet:

(1) To maximize the torque generated by the permanent magnet by increasing its surface area that occupies the area of one pole for ensuring the maximized torque;
(2) To realize the configuration which allows sufficient use of reluctance torque;
(3) To ensure thickness of the permanent magnet so as not to cause demagnetization owing to lower retentivity of the permanent magnet as low as ⅓ upon supply of current to the stator winding; and
(4) To reduce the torque ripple at the maximum torque in applying the maximum current in order to cope with increase in the torque ripple owing to increasing higher harmonic magnetic flux that passes through the core, in principle, caused by the use of reluctance torque.

Patent Literature 1 discloses the permanent magnet motor structure utilizing the permanent magnet torque and the reluctance torque derived from the permanent magnet implanted in the rotator core as the closest example to the case as described above.

FIG. 7 of Patent Literature 1 discloses the aforementioned structure having the permanent magnet implanted in the rotator core as the closest subject to that of the present invention. Features and subjects of the structure will be described referring to FIGS. 9 and 10.

Permanent magnets are arranged at four poles, one of which includes four rectangular parallelepiped permanent magnets 61 to 64. The permanent magnet 64 is disposed longitudinally in the peripheral direction on an outer periphery of a d-axis rotator, and the remaining three permanent magnets 61, 62, 63 are arranged to form a U-shape as shown in the drawing. Patent Literature 1 discloses the invention aiming at improvement of the feature by partially adding the permanent magnet to the reluctance motor. The reluctance torque depends on a central salient pole 74 formed between the permanent magnets arranged in U-shape at the position corresponding to a q-axis.

Generally, a torque equation of the permanent magnet motor for generating the reluctance torque and the permanent magnet torque simultaneously is expressed as the following equation 1:

τ=ρ[keiq+(Ld−Lq)idiq] (Equation 1)

where p: number of pole pairs, ke: induced voltage constant, Ld: d-axis inductance, Lq: q-axis inductance, id: d-axis current, iq: q-axis current.

As for the above equation, the first term denotes the torque component derived from the permanent magnet, and the second term denotes the reluctance torque component. The permanent magnet torque as the first term is proportional to the induced voltage constant ke. The induced voltage constant ke is substantially proportional to a residual magnetic flux density Br and an area Am of the permanent magnet.

Meanwhile, the reluctance torque is proportional to (Ld−Lq). The Ld is proportional to the magnetic flux amount φd obtained upon supply of constant current to the d-axis, and Lq is proportional to the magnetic flux amount φq obtained upon supply of constant current to the q-axis.

Patent Literature 1 discloses the structure which allows utilization of both the aforementioned permanent magnet torque generated through arrangement of the four permanent magnets 61 to 64, and the reluctance torque generated through the central salient pole 74 as described above. The torque generated by the permanent magnet is proportional to values of the residual magnetic flux density and area of the permanent magnets 61, 62, 63 arranged in a U-shape, and generated by adding values of the residual magnetic flux density and area of the permanent magnet 64 that constitutes the magnetic circuit in series to those values.

The reluctance torque will be described. When the current Id is applied to the d-axis as shown in FIG. 9, each magnetic resistance of the permanent magnets 64 as well as 61, 62, 63 is increased as permeability of the permanent magnet of the d-axis magnetic circuit is as small as 1, and the magnet has the thickness larger than the opening between the stator and the rotator, thus making the d-axis magnetic flux φd1 small. Accordingly, the d-axis inductance Ld proportional to the d-axis magnetic flux φd1 is also made small.

Meanwhile, when applying the current Iq to the q-axis as shown in FIG. 9, the magnetic resistance of the q-axis magnetic circuit may be made small, and the magnetic flux φd of the q-axis may be made large because iron of the magnetic pole 74 has the relative permeability of 1000 or higher. Then the q-axis inductance Lq proportional to the q-axis magnetic flux φq also becomes large. The aforementioned principle allows (Ld-Lq) to be made large (sign is opposite, but it becomes positive owing to the negative sign of Id). This makes it possible to generate the large reluctance torque. Patent Literature 1 discloses the permanent magnet motor capable of generating the permanent magnet torque and the reluctance torque simultaneously on the basis of the aforementioned theory.

Patent Literature 2 discloses the permanent magnet motor structure utilizing the reluctance torque, in other words, using the implanted rotator structure to reduce the cogging torque. Patent Literature 2 disclose the permanent magnet motor with fractional slot structure, in which the value Ns/P/M obtained by dividing the number of stator slots Ns by the number of poles P and the number of phase M of the permanent magnet becomes the common fraction. Specifically, the disclosed structure defines the width of the permanent magnet pole capable of reducing the cogging torque when the current is not applied.

### RELATED ART

### Patent Literature

Patent Literature 1: Japanese Patent No. 3290392
Patent Literature 2: JP-A-2003-79192

### SUMMARY OF THE INVENTION

### Problem to be Solved by the Invention

Patent Literature 1 represents the structure with four permanent magnets arranged between central salient poles, and the width of the central salient pole is made larger than that of the slot of the stator, utilizing the reluctance torque and the permanent magnet torque. However, the literature does not disclose the permanent magnet motor structure for complementing the disadvantageous feature of the ferrite magnet with the low residual magnetic flux density of the ferrite magnet, that is, sufficient expansion of the surface area of the permanent magnet to approximate the torque to the one generated by the generally employed neodymium magnet motor as close as possible.

In reference to Patent Literature 1, the use of the neodymium magnet only, or neodymium magnet, ferrite, and bonded magnet together as the permanent magnet leads to large residual magnetic flux density. Therefore, the area of the permanent magnet does not have to be necessarily maximized for making the large permanent magnet torque as the first term of the equation 1. As the structure is an improvement of the reluctance motor, the width of the central salient pole 74 is sufficiently large compared with the slot pitch of the stator. This may realize the feature that allows the intended motor for driving the automobile to retain the maximum output up to the high-speed area.

The literature does not disclose the structure for maximizing the permanent magnet torque as the subject upon use of the ferrite magnet with low residual magnetic flux density, that is, the structure for increasing the area of the permanent magnet. It is difficult for the structure with enlarged central salient pole 74 shown in Patent Literature 1 to maximize the area of the permanent magnet, resulting in the problem of impossibility of sufficiently increasing the permanent magnet torque.

As for the reluctance torque, when the current Iq is applied to the q-axis using the permanent magnet motor that generates large torque, the q-axis magnetic circuit is not capable of making large q-axis magnetic flux φq1 owing to magnetic saturation at the stator side. Accordingly, it is impossible to realize large Lq. The d-axis magnetic circuit is capable of reducing the magnetic flux φd1 according to the aforementioned theory. However, the large width of the central salient pole 74 causes the magnetic flux φq2 that passes across the central salient pole 74 in the d-axis direction. On the magnetic path of φd2, permeability of iron that constitutes the central salient pole 74 is as high as 1000 or greater, and magnetic resistance is small owing to the opening length as short as the gap between the stator and the rotator. Therefore, the magnetic flux φd of the d-axis is enlarged. It is therefore difficult to enlarge the absolute value of (Ld-Lq), causing the problem of maximizing the reluctance torque.

The d-axis magnetic flux φd2 which has the adverse effect on acquisition of the large reluctance torque as described above may cause generation of pulsating torque, thus demanding the low torque ripple upon generation of the maximum torque.

Patent Literatures 1 and 2 do not disclose the structure for reducing the torque ripple of the permanent magnet motor in the state where the reluctance torque is generated through current application to the winding of the permanent magnet motor.

The present invention provides the permanent magnet motor using ferrite magnet, which is configured to maximize the torque of the permanent magnet and the reluctance torque, and minimize the torque ripple upon application of current by overcoming the drawback of the generally employed permanent magnet motor.

### Means for Solving the Problem

The invention according to claim 1 provides a permanent magnet motor which includes a permanent magnet rotator of P-pole-implanted type having a ferrite permanent magnet contained in a laminated silicon steel sheet, in which a U-shaped permanent magnet including three parts and an outer-periphery permanent magnet disposed longitudinally in the peripheral direction at the outer periphery of the U-shaped permanent magnet are provided at one pole to generate permanent magnet torque, and two salient poles formed between the U-shaped permanent magnet and the outer-periphery permanent magnet, and one central salient pole formed between the U-shaped permanent magnets of adjacent poles are provided at one pole to generate reluctance torque, and a stator including a distributed M-phase stator winding and a laminated stator core having Ns slots for storing the stator winding, a ratio of Ns/M/P being a common fraction. When a width of the central salient pole is set to τcp and a slot pitch of the stator core is set to τs, the central salient pole width τcp is smaller than the slot pitch τs.

In the invention of claim 2 relating to the permanent magnet motor according to claim 1, when each width of two salient poles formed between the U-shaped permanent magnet and the outer-periphery permanent magnet is set to τbp, the width τbp is smaller than the slot pitch τs.

In the invention of claim 3 relating to the permanent magnet motor according to claim 2, a ratio between the width τcp of the central salient pole and the slot pitch τs is set to a relationship of 0.1<τcp/τs<1.0.

In the invention of claim 4 relating to the permanent magnet motor according to claim 3, the ratio between the width τcp of the central salient pole and the slot pitch τs is set to a relationship of 0.35<τcp/τs<0.7.

In the invention of claim 5 relating to the permanent magnet motor according to claim 2, at one pole, a ratio between a total width τap including the width τbp of the salient pole formed between the U-shaped permanent magnet and the outer-periphery permanent magnet and the width τcp of the central salient pole, and the slot pitch τs is set to a relationship of 2.1<τap/τs<3.35.

In the invention of claim 6 relating to the permanent magnet motor according to claim 5, the ratio is set to a relationship of 2.57<τap/τs<2.84.

### Advantageous Effect of Invention

According to the invention of claim 1, the width τcp of the central salient pole is made smaller than the slot pitch τs to maximize the sum of the permanent magnet torque and the reluctance torque upon generation of the maximum torque during application of the maximum current, and to allow the torque ripple reduction.

According to the invention of claim 2, each width of τbp and τcp is made smaller than the slot pitch τs. This makes it possible to maximize the sum of the permanent magnet torque and the reluctance torque upon application of maximum current, and to allow minimization of the torque ripple ratio.

According to the invention of claim 3, the ratio between the width τcp of the central salient pole formed between U-shaped permanent magnets of adjacent poles and the slot pitch τs of the stator core is set to establish the relationship of 0.1<τcp/τs<1.0 so as to maximize the sum of the permanent magnet torque and the reluctance torque upon application of maximum current, and to allow reduction in the torque ripple ratio.

According to the invention of claim 4, assuming that the width of the central salient pole formed between the U-shaped permanent magnets of the adjacent poles is set to τcp, the ratio between the width τcp of the central salient pole and the slot pitch τs is set to the relationship of 0.35<τcp/τs<0.7 so as to allow maximization of the sum of the permanent magnet torque and the reluctance torque upon application of maximum current, and reduction in the torque ripple.

According to the invention of claim 5, the ratio between a total width τap which includes the width τbp of the salient pole formed between the U-shaped permanent magnet and the permanent magnet disposed longitudinally in the peripheral direction at an outer periphery of the U-shaped permanent magnet and the width τcp of the central salient pole formed between the U-shaped permanent magnets of the adjacent poles, and the slot pitch τs is set to the relationship of 2.1<τap/τs<3.35. This may maximize the sum of the permanent magnet torque and the reluctance torque upon application of maximum current, and reduce the torque ripple.

According to the invention of claim 6, the ratio between the τap and τs is set to the relationship of 2.57<τap/τs<2.84 so as to maximize the sum of the permanent magnet torque and the reluctance torque upon application of maximum current and to allow further reduction in the torque ripple.

### BRIEF DESCRIPTION OF DRAWING

FIG. 1 is a sectional view of an essential part of a permanent magnet motor according to an embodiment of the present invention.

FIG. 2 is a view illustrating an overall structure of the permanent magnet motor according to the embodiment of the present invention.

FIG. 3 is a sectional view of the permanent magnet motor in an axial direction according to the embodiment of the present invention.

FIG. 4 is an explanatory view representing an operation principle of the permanent magnet motor according to the present invention.

FIG. 5 is an explanatory view representing an operation principle of the permanent magnet motor according to the present invention.

FIG. 6 is a characteristic diagram showing values of the torque ripple and the torque corresponding to the ratio between the width τcp of the central salient pole of the permanent magnet motor and the slot pitch τs according to the embodiment of the present invention.

FIG. 7 is a characteristic diagram showing values of the torque ripple and the torque corresponding to the ratio between the width τap of the salient pole of the permanent magnet motor and the slot pitch τs according to the embodiment of the present invention.

FIG. 8 is a characteristic diagram of a cogging torque with respect to the ratio τcp/τs between the width τcp of the central salient pole of the permanent magnet motor and the slot pitch τs according to the embodiment of the present invention.

FIG. 9 is an explanatory view representing an operation principle of the generally employed permanent magnet motor.

FIG. 10 is an explanatory view representing an operation principle of the generally employed permanent magnet motor.

### MODE FOR CARRYING OUT THE INVENTION

An embodiment of the present invention will be described referring to the drawings.

### Embodiment

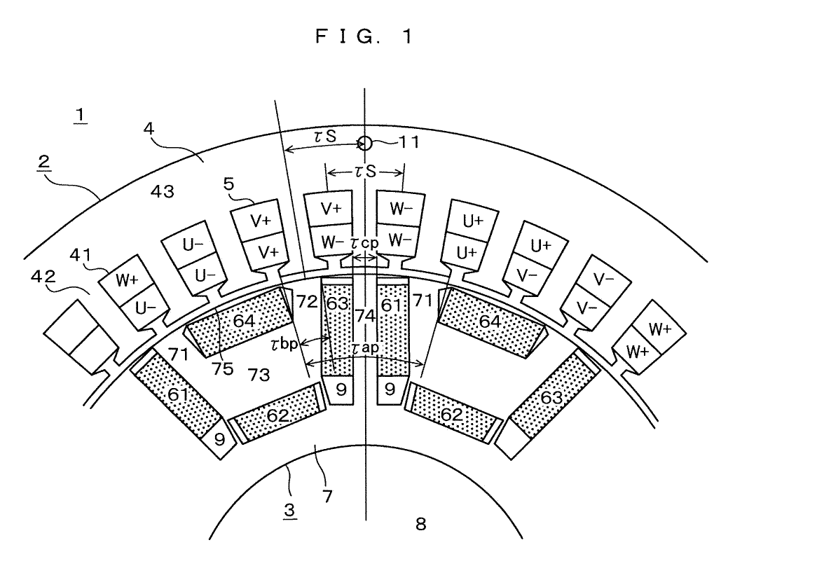

FIG. 1 is a sectional view of an essential part of a permanent magnet motor according to an embodiment of the present invention.

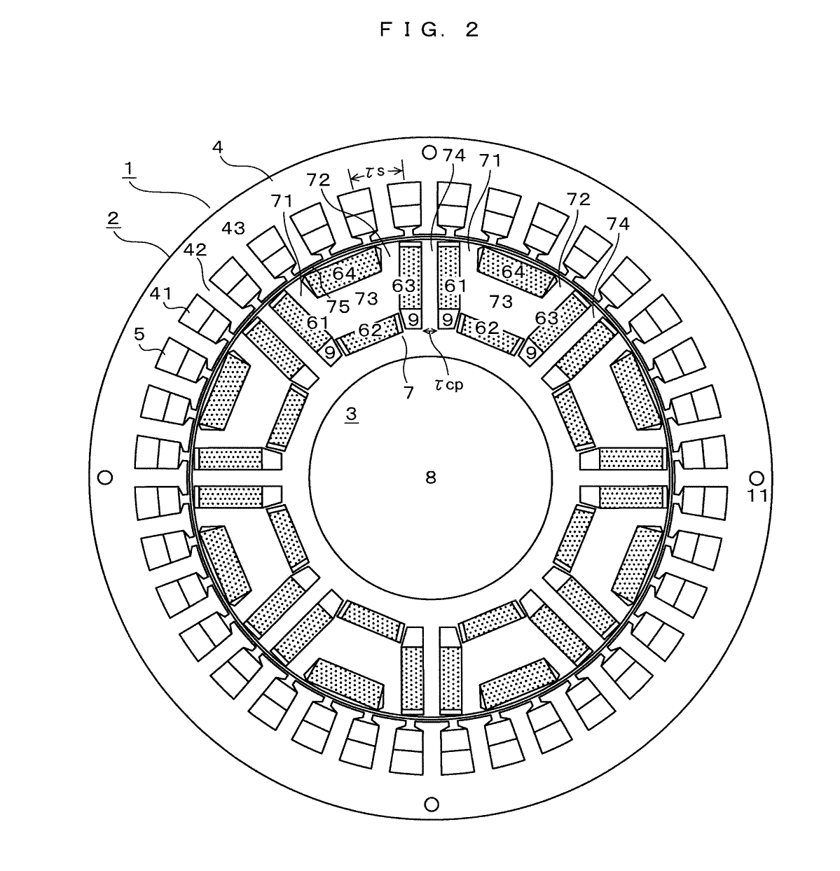

FIG. 2 is a view illustrating an overall structure of the permanent magnet motor according to the embodiment of the present invention.

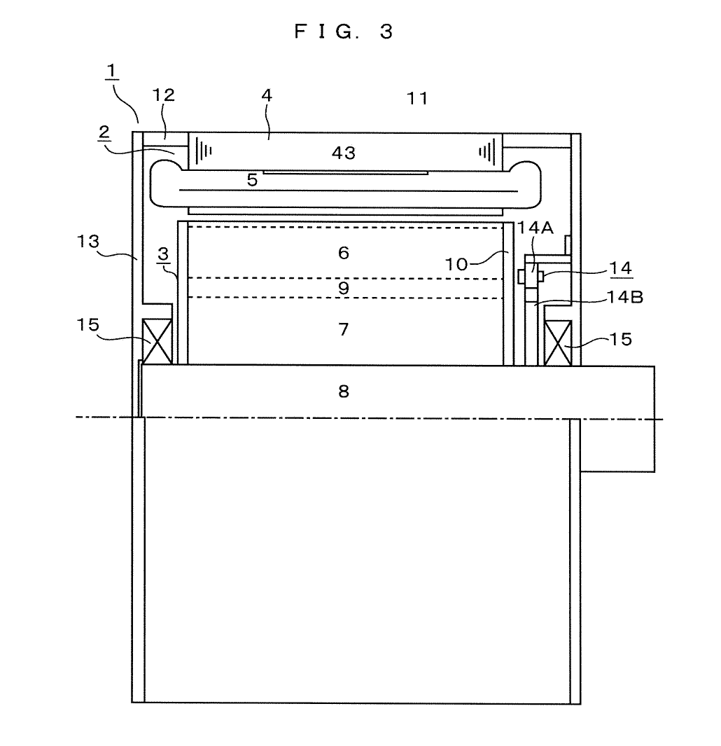

FIG. 3 is a sectional view of the permanent magnet motor in an axial direction according to the embodiment of the present invention.

FIG. 1 illustrates an enlarged part of two poles shown in FIG. 2. Referring to the drawing, the element only with a numeral denotes a part, and the underlined numeral denotes the group of parts.

As the drawing shows, a permanent motor 1 includes a stator (stationary part) 2 and a rotator (permanent magnet rotator) 3. The stator 2 is mainly formed of a stator core 4 and a stator winding 5. Meanwhile, the rotator 3 is formed of a permanent magnet 6, a rotator core 7 as a laminated silicon steel sheet, a shaft 8, and a magnet holding member 10 for suppressing axial movement of the permanent magnet. The stator 2 is configured to be fixed to an end plate 13 at both axial ends using a stator pin 11 that penetrates through the stator core 4, and an end bracket 12.

The rotator 3 is rotatably supported at the end plate 13 via a bearing 15. A position detector 14 for detecting a position of the rotator 3 includes a stator 14A fixed to the end plate 13, and a rotator 14B fixed onto an axis of the shaft 8. In this case, a resolver is shown as the position detector 14.

A slot 41 for storing the stator winding 5 is formed in an inner periphery of the stator core 4. Referring to the drawing, the stator core 4 is made from an electromagnetic laminated silicon steel sheet with thickness of 0.5 mm, for example, and includes a hole for the stator pin 11, the slot 41 for storing the stator winding 5, stator teeth 42 and stator core backs 43 that constitute the magnetic circuit of the permanent magnet 6 of the rotator 3. Additionally, a cooling fin may be integrally molded with the outer periphery as needed. It is possible to weld the outer periphery of the stator core 4 as a laminated member if necessary for the purpose of enhancing mechanical strength.

The embodiment of the present invention provides the permanent magnet motor, which includes the stator formed of the distributed M-phase stator winding 5 and the laminated stator core with Ns slots for storing the respective stator cores, and a P-pole rotator as well as the structure having the ratio of Ns/P/M being a common fraction.

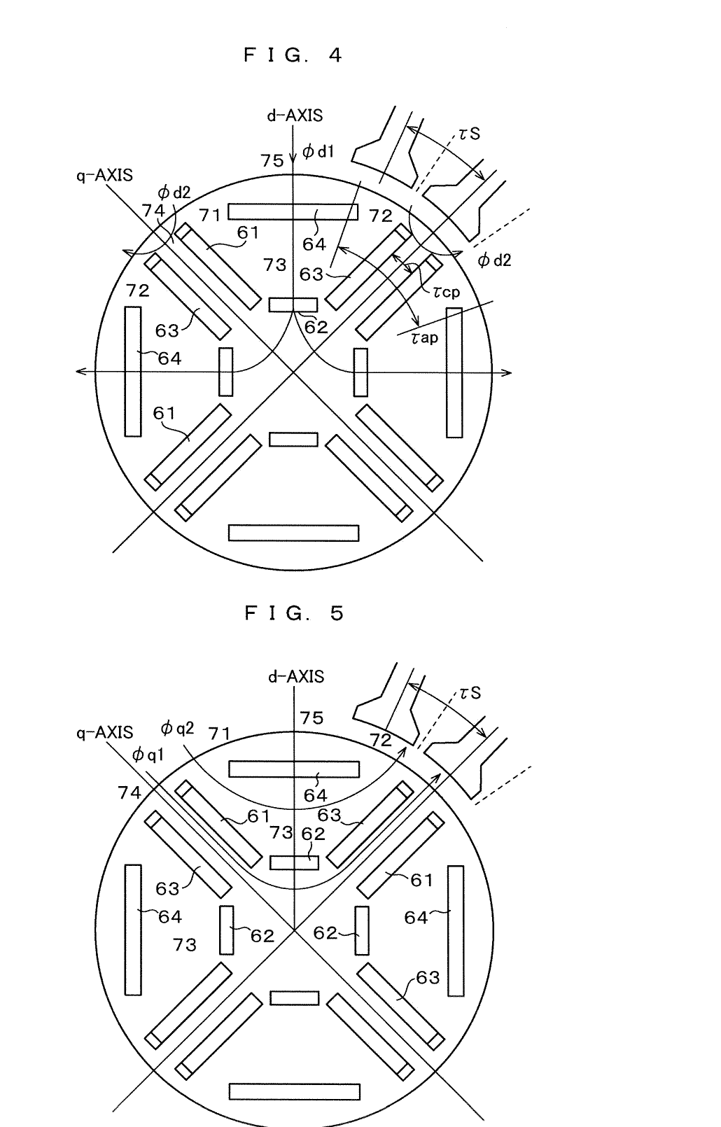

This embodiment will describe the permanent magnet motor with the structure having the ratio between the number P of poles of rotators and the number Ns of the stator slots set to 2:9 as an example. Therefore, the width is of one slot in the peripheral direction (slot pitch) is expressed in the range shown in the drawing. There are 4.5 slots formed for each pole (electrical) angle:180°, and accordingly, the resultant electrical angle is 40°. As FIG. 1 shows, each pitch of the slot 41 and the stator teeth 42 is the same as “τs”. The pitch of the stator teeth 42 is designated as “τs” in FIGS. 4 and 5.

The following example will be made on the assumption that the number Ns of slots of the stator core is 36, and the number P of poles of the rotator 3 is 8. It is assumed that the phase-number M of the stator winding 5 of the permanent magnet motor 1 is set to 3 as a widely distributed number in general. In other words, the number of slots for each pole/phase, Nspp=Ns/P/M is 3/2 as a fractional slot rather than that of integer. Therefore, the structure with 36 slots of the stator 2 and 8 poles of the rotator corresponds to the one where the slot combination of 9 slots and 2 poles of the rotator is repeated four times in the peripheral direction.

The structure of the rotator of the permanent magnet motor as an object of the embodiment according to the present invention will be described. The rotator 3 constitutes the magnetic circuit together with the permanent magnet 6 and the rotator core 7. A rectangular parallelepiped ferrite magnet which is low in price and allowed to be easily manufactured is employed for forming the permanent magnet 6. The rotator core 7 is manufactured using the laminated silicon steel sheet likewise the stator core 4.

Three rectangular parallelepiped ferrite magnets 61, 62, 63 which are implanted in the laminated silicon steel sheet to form the U-shape as shown in the drawing, and an outer-periphery permanent magnet 64 as the rectangular parallelepiped ferrite disposed longitudinally in the peripheral direction at the outer periphery of the rotator of the U-shaped permanent magnets, that is, four magnets in total are used to form the permanent magnet at one pole.

As a result, salient poles 71, 72 formed between the U-shaped permanent magnet (61, 62, 63) and the outer-periphery permanent magnet 64 disposed longitudinally in the peripheral direction at the outer periphery of the rotator of the U-shaped permanent magnet, and a central salient pole 74 formed between the U-shaped permanent magnets of the adjacent poles are formed on the rotator surface.

With the aforementioned structure, there are two magnetic circuits of the permanent magnet, including the one that passes from the three permanent magnets 61, 62, 63 to the stator via the salient poles 71, 72, and the one that passes to the stator via the outer-periphery permanent magnet 64.

The permanent magnet motor 1 according to the embodiment of the present invention has the aforementioned structure, and is characterized that when the width of the central salient pole 74 formed between the U-shaped permanent magnets of adjacent poles is set to τcp, and the pitch of the slot 42 of the stator core 4 is set to τs, τcp is smaller than the is (τcp<τs). It is further characterized that the permanent magnet 62 that partially constitutes the U-shaped magnet at the inner diameter side is disposed to be closer to the inner diameter than the radially arranged permanent magnets 61, 63.

FIGS. 4 and 5 show the operation principle indicating the effect of the embodiment according to the present invention. FIG. 4 shows the d-axis magnetic circuit, and FIG. 5 shows the q-axis magnetic circuit. The structure has 4 poles likewise the related art for the purpose of clarifying the difference between the related art and the embodiment of the present invention.

In the structure of the embodiment according to the present invention, the width τcp of the central salient pole is set to a small value so that the permanent magnets 61, 63 disposed in the radial direction of the U-shaped permanent magnet are located near the central salient pole 74 as close as possible, and the permanent magnet 62 may be disposed at the position closer to the inner diameter. This makes it possible to extend each radial length of the permanent magnets 61, 63. The aforementioned structure allows the whole surface area of the three permanent magnets 61, 62, 63 to be large. As the induced voltage constant Ke increases in proportion to the residual magnetic flux density Br and an area Am of the permanent magnet. The permanent magnet torque expressed in the equation 1 may be increased. This makes it possible to enhance the effect that compensates for torque reduction caused by the lower residual magnetic flux density of the ferrite magnet than that of the neodymium magnet.

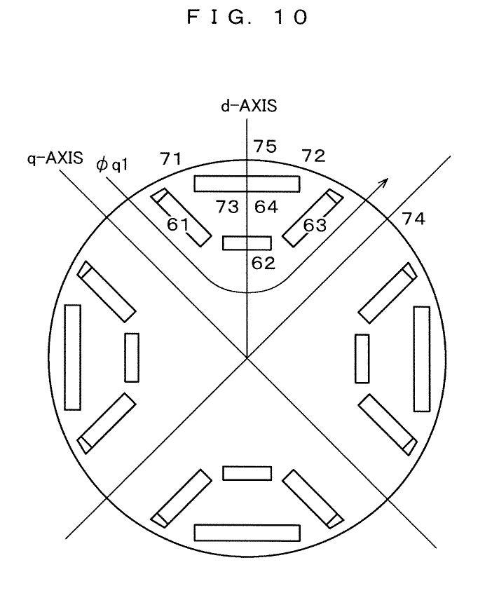

The reluctance torque will be described. When applying the current Id to the d-axis shown in FIG. 4, permeability of the permanent magnet of the d-axis magnetic circuit is as small as 1, and the magnet has the thickness larger than the opening likewise the related art shown in FIG. 9 so that the magnetic resistance of the permanent magnets including not only 64 but also 61, 62, 63 becomes large, and the d-axis magnetic flux αd1 becomes small. Therefore, the d-axis inductance Ld proportional to the d-axis magnetic flux αd1 also becomes small.

Meanwhile, the magnetic flux φd2 shown in FIG. 9 as related art, which passes across the central salient pole 74 in the d-axis direction becomes small because of the magnetic resistance increased by reduction in the area of the magnetic circuit resulting from narrowed width τcp of the central salient pole 74. Accordingly, unlike the related art, the embodiment is effective to prevent increase in the d-axis inductance Ld. This makes it possible to reduce the d-axis inductance as a whole. Decrease in the magnetic flux αd2 having an adverse effect on generation of the reluctance torque lessens cause of the torque pulsation associated with increase in the reluctance torque as the problem for the permanent magnet motor that generates the reluctance torque. This makes it possible to realize the low torque ripple.

As FIG. 5 shows, likewise the related art shown in FIG. 10, when applying the current Iq to the q-axis, the magnetic resistance of the q-axis magnetic circuit may be made small and the q-axis magnetic flux φq may also be made large as iron of the magnetic pole 74 has permeability as high as 1000 or greater. Accordingly, the q-axis inductance Lq proportional to the q-axis magnetic flux φq becomes large.

Although the narrow width τcp of the central salient pole 74 makes the magnetic flux φq1 small, the magnetic flux φq2 flowing between the salient poles 71 and 72 compensates for the small magnetic flux. This may prevent the q-axis inductance Lq from being small. Therefore, overall, the absolute value of (Ld−Lq) becomes large to increase the reluctance torque, thus producing the effect for reducing the torque ripple. The q-axis magnetic flux (φq1, φq2) flows through the magnetic circuit of the central salient pole 74, and between the salient poles 71 and 72 respectively with good balance. This may establish the torque increase and the low torque ripple while eliminating partial saturation inside the rotator.

The torque of the permanent magnet motor using both the permanent magnet torque and the reluctance torque has been expressed by the equation 1. The structure according to the embodiment of the present invention allows the induced voltage constant Ke to be made large by increasing the surface area of the permanent magnet. It is effective for increasing the permanent magnet torque in the first term of the equation 1. The aforementioned structure is not always capable of enlarging the q-axis inductance Lq through saturation and the like. However, the d-axis inductance Ld may be reduced by dividing the magnetic circuit with the outer-peripheral permanent magnet 64 disposed longitudinally in the peripheral direction at the outer periphery of the U-shaped permanent magnet, and decreasing the magnetic flux φd2 with narrowed central salient pole width τcp. This makes it possible to enlarge the reluctance torque.

Increasing each width τbp of the two salient poles 71, 72 generates the magnetic flux from the stator winding to orbit the salient pole of the rotator likewise the magnetic flux φd2, resulting in the risk of giving the adverse effect on the torque. The embodiment of the present invention is effective for improving the reluctance torque by setting the width τbp to be smaller than the slot pitch τs of the stator core.

As described above, when applying the current to the stator winding in the structure having each width τbp of the salient poles 71, 72 and the width τcp of the central salient pole 74 smaller than the slot pitch τs, the magnetic flux orbiting inside the rotator may be made small. Furthermore, it is possible to increase the torque and reduce the torque ripple as described above as well as reduce the leakage inductance of the stator winding. It is also effective to improve the power factor of the permanent magnet motor. Improved power factor contributes to the reduced voltage source capacity and improved output.

Referring back to FIGS. 1 and 2, besides the above-described structure of the rotator according to the embodiment of the present invention, the structure may be provided with an opening 9 for preventing the short circuit at both ends of the respective permanent magnets of the rotator, and a rotator magnetic path 73 and a magnetic pole piece 75 (magnetic pole between the permanent magnet 64 and an outer periphery of the rotator) which constitute the magnetic path of the rotator. Bridge portions connected with thin silicon steel sheets are formed between the rotator magnetic path 73 and the rotator core at the inner-periphery side, the salient poles 71 and 74, and 72 and 74, respectively.

FIG. 1 shows the winding arrangement of two poles with nine slots. Marks including U, V and W denote winding corresponding to the respective phases. The plus sign denotes the direction of the current flowing from the back surface to the upper surface of the sheet of the drawing, and the minus sign denotes the opposite winding direction. Not shown slots are arranged by forming nine slots as shown in the drawing repeatedly three times. They are connected in series so as to be driven by a single inverter. If the motor is of large output type, the 3-phase winding corresponding to 9 slots is driven by the single inverter, and the other may be driven by the other 3 inverters.

Advantageous points of the fractional slot with 2-pole and 9-slot structure will be described.

Phases corresponding to poles of the rotator of the respective stator windings for each phase are different. Therefore, it is possible to effectively lessen the influence of harmonics without reducing the value of the winding factor to fundamental wave. As for the motor, it is possible to provide the permanent magnet motor with less torque ripple. The structure with fractional slot is indispensable technique for the permanent magnet motor positively utilizing the reluctance torque according to the embodiment of the present invention as employment of the reluctance torque lessens the increase in torque pulsation. Employment of the fractional slot makes it possible to reduce the torque ripple to the practical level. There is no need of the structure such as skew for reducing the torque ripple, thus lessening man-hours. It is also advantageous to increase torque in comparison with the skewed motor with integer slot.

Meanwhile, the combination of the numbers of poles and slots may suppress increase in the torque ripple of the permanent magnet motor utilizing reluctance torque as described above. It is therefore necessary to account for reduction in the torque ripple caused by magnetomotive force with different harmonics because of different winding arrangement to the general integer slots having Nspp as being integer.

Analysis was made with respect to simulation of torque and torque ripple of the permanent magnet motor utilizing the rectangular parallelepiped ferrite magnet according to the embodiment of the present invention with maximum torque of 4 kNm, maximum output of approximately 120 kW, outer size of φ400, and stator core axial length of 400 mm.

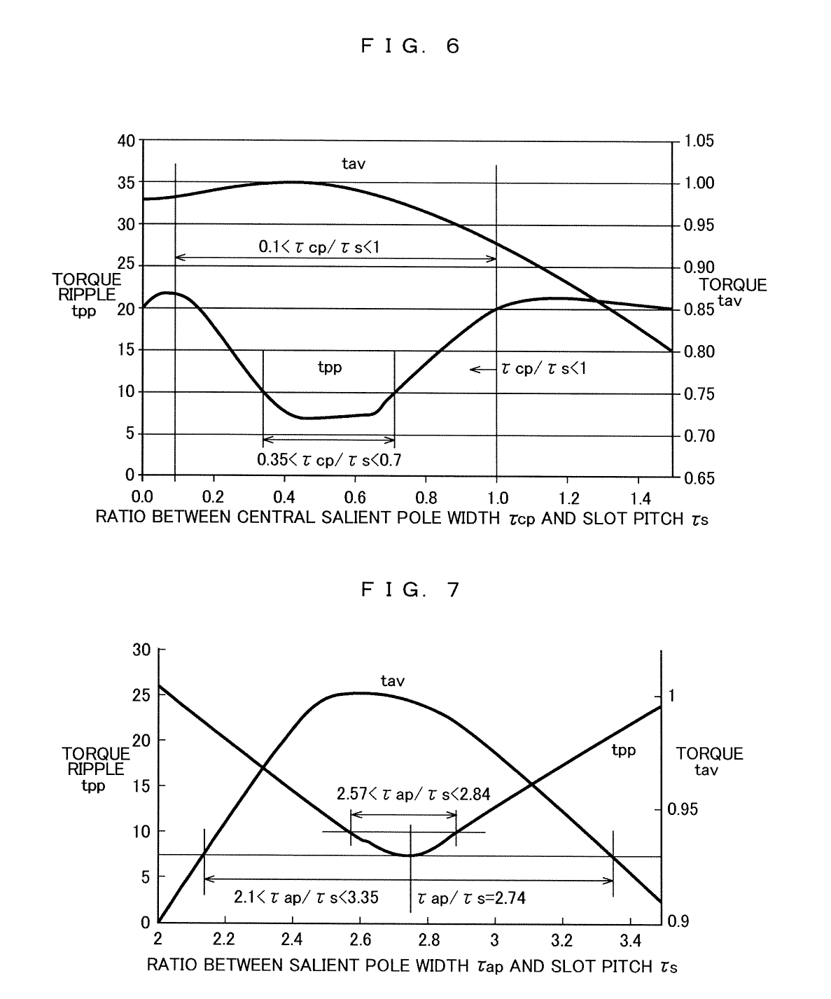

FIG. 6 represents values of the torque ripple tpp and the torque tav with respect to the ratio between the central salient pole width τcp and the slot pitch τs of the permanent magnet motor.

FIG. 7 represents values of the torque ripple tpp and the torque tav with respect to the ratio between the salient pole width τap and the slot pitch τs of the permanent magnet motor.

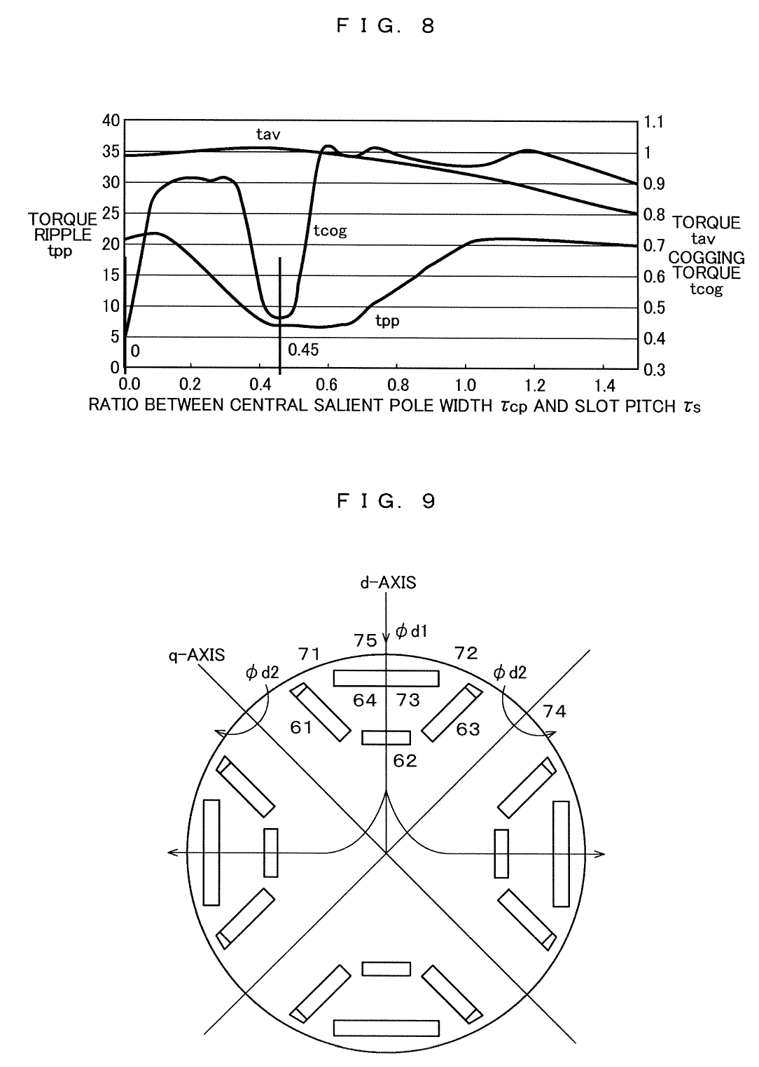

FIG. 8 represents values of the cogging torque tcog with respect to the ratio τcp/τs between the central salient pole width τcp and the slot pitch τs of the permanent magnet motor. The torque tav as one of elements of the y-axis is expressed in a dimensionless way through division by the maximum value in the analysis. The torque ripple tpp as the other element of the y-axis is expressed in percentage by dividing the difference between maximum and minimum values of the torque ripple by the average value of the torque. The cogging torque tcog is expressed in the ratio with respect to the maximum value.

The analysis was conducted with respect to the permanent magnet motor as an object, in which the ampere conductor as the index for designing the motor with respect to the opening (product of winding and current per unit peripheral length on the opening surface) reaches 1500 A/cm at maximum current (maximum torque), and the large torque corresponding to the torque/volume of 100 Nm/l (liter) is generated.

Various parameters need to be considered to give an influence on the torque and torque ripple in designing the motor. The embodiment of the present invention provides the permanent magnet motor that uses the ferrite magnet with especially low magnetic flux, and demands sufficient utilization of the reluctance torque. It is focused with respect to the significant influence of the central salient pole width τcp on the torque and the torque ripple. FIG. 6 represents values of the torque ripple and the torque with respect to the ratio between the central salient pole width τcp and the slot pitch τs of the permanent magnet motor. Change in the torque ripple relative to the ratio τcp/τs shows that the result of increase in the torque as the ratio τcp/τs is made small as shown in the drawing. This justifies the principle shown in FIGS. 4 and 5, on which the embodiment of the invention is based.

Referring to FIG. 6, compared with the related art which takes the value of τcp/τs as 1.5, the embodiment of the present invention takes the value of τcp/τs as 1 or smaller so as to allow marked improvement of the torque tav. It has been discovered that selection of the ratio between the central salient pole width τcp formed between the U-shaped permanent magnets of the adjacent poles, and the slot pitch τs of the stator core, which is set to 0.1<τcp/τs<1.0 allows establishment of both large torque and low torque ripple simultaneously.

Furthermore, as for the torque ripple tpp referring to FIG. 6, it has been discovered that setting of the ratio τcp/τs to be in the range from 0.35 to 0.7 makes it possible to suppress the torque ripple to be equal to or lower than 10%, and to ensure large torque tav.

In the embodiment of the present invention, reduction in the width τcp of the central salient pole 74 allows establishment of large torque and low torque ripple simultaneously.

It is focused that the torque and the torque ripple are significantly influenced by the central salient pole width τcp, and an overall salient pole width τap derived from the salient poles 71, 72 formed between the U-shaped magnets 61, 62, 63 for mainly generating the reluctance torque and the outer-periphery permanent magnet 64 disposed longitudinally in the peripheral direction at the outer periphery, and the central salient pole 74 formed between the U-shaped magnets 61, 63 of the adjacent poles.

The aforementioned analysis is actually calculated by changing the circumferential length of the rotator of the permanent magnet 64. As a result, the range of τap/τs suitable for enlargement of the average torque tav with respect to the ratio τap/τs has been clarified. The point at which the torque ripple is minimized has also been clarified, which is at the different location from that of the τap/τs for exerting the maximum average torque as described above.

As FIG. 7 shows, setting of τap/τs to 2.1<τap/τs<3.35 enlarges the average torque tav. Within this range, it is possible to generate the torque having the average torque tav in excess of the one obtained in the range of τcp/τs as shown in FIG. 6. It has also been clarified from the analytical result as shown in FIG. 7 that the torque ripple is minimized at the point where the τap/τs takes the value of 2.74. In this case, it is possible to reduce the minimum torque ripple down to 7%. Practically, the torque ripple set to 10% or less is applicable. Therefore, setting the relationship of 2.57<τap/τs<2.84 by taking the aforementioned point of 2.74 as the center realizes the best range for ensuring 10% or less of the torque ripple.

In the aforementioned region, the point at which the torque is maximized is slightly different from the point at which the torque ripple is minimized. In this range, however, the sensitivity to the torque is relatively low so that the range may be identified as being suitable for the motor feature in preference to the range where the torque ripple is minimized.

In the reluctance motor of permanent magnet type employed as an object of the embodiment of the present invention, the ratio between the magnet width (outer-periphery width of rotator of the magnetic pole piece 75)/magnetic pole pitch has an optimum value which allows the magnet width and the width of the reluctance magnetic pole to be in a well-balanced state, that is, maximized in view of the output torque. In other words, if the magnet is enlarged, the magnet torque is increased, but the reluctance torque is reduced. If the magnet is made small, the magnet torque is reduced, but the reluctance torque is increased. This phenomenon has no relation with the slot pitch. Selection of the aforementioned τcp/τs allows selection of the magnet width/magnetic pole pitch for giving the maximum torque.

In the resultant range, each width τbp of the salient poles 71, 72 is smaller than the slot pitch τs of the stator core. This shows that the effect of blocking the magnetic flux such as 02 generated by the stator winding, which orbits the salient pole of the rotator functions to improve the torque and reduce the torque ripple.

The width of the central salient pole of the permanent magnet motor disclosed in Patent Literature 1 is approximately ⅓ or larger of the width of at least one pole in the peripheral direction. If it is modified to have the 2-pole and 9-slot structure, it may be assumed that the structure with 2-slot pitch or larger is only disclosed. The result shown in FIG. 7 indicates that the generally employed structure reduces the torque generation.

The structure according to the embodiment of the present invention enlarges the area of the permanent magnet for maximizing the permanent magnet torque, and adjusts each width of three salient poles formed on the surface for appropriately suppressing increase in the d-axis inductance owing to the central salient pole. Furthermore, generation of the reluctance torque while having the well-balanced state of the width among three salient poles allows maximization of the generated torque, and minimization of the torque ripple.

FIG. 8 represents values of the cogging torque with respect to the ratio τcp/τs between the central salient pole width τcp and the slot pitch τs of the permanent magnet motor. The cogging torque is an important index which gives an influence on the positioning accuracy and noise at the low speed. The structure with the ratio between the magnetic pole of the rotator and the number of slots set to 2:9 reveals the influence of the cogging torque on the structure having the permanent magnets arranged as shown in FIG. 1. The cogging torque is the torque ripple which occurs when current is not applied to the stator winding. In the structure with the ratio between the rotator magnetic pole and the number of the slots set to 2:9, the torque has 18 pulsation cycles as the least common multiple of both properties for each magnetic pole pair.

The cogging torque has its magnitude largely influenced by the magnetic pole width (sum of those of the salient poles 71, 72, and the magnetic pole piece 75) of the rotator defined by the permanent magnets 61, 62, 63. Generally, it represents the special generation process through combination with the number of stator slots of the special fractional slot as described above. The result as shown in FIG. 8 has revealed the feature that provides the minimum value when the value of τcp/τs is at the point of 0 or 0.45. Selection of the aforementioned ratios allows the cogging torque to be minimized. It is discovered that, especially at τcp/τs set to 0.45, the structure is capable of reducing the pulsation torque (torque ripple) and increasing the torque as well as reducing the cogging torque. The aforementioned point may be expressed as the ratio between the pole width and the pitch of the permanent magnet. Specifically, the point corresponding to τcp/τs=0 is 0.77, and the point corresponding to τcp/τs=0.45 is 0.65. The aforementioned structure is capable of forming the permanent magnet motor with small cogging torque.

### DESCRIPTION OF SIGNS

1 . . . permanent magnet motor, 2 . . . stator (stationary part), 3 . . . rotator (permanent magnet rotator), 4 . . . stator core (stator iron core), 41 . . . slot, 42 . . . stator teeth, 43 . . . stator core back, 5 . . . stator winding (stationary part winding), 6 . . . permanent magnet, 61,62,63,64 . . . permanent magnet, 61, 62, 63 . . . U-shaped permanent magnet, 64 . . . outer-periphery permanent magnet, 7 . . . rotator core, 71,72 . . . salient pole, 73 . . . rotator magnetic path, 74 . . . central salient pole, 75 . . . magnetic pole piece, 8 . . . shaft, 9 . . . opening, 10 . . . magnet holding member, 11 . . . stator pin, 12 . . . end bracket, 13 . . . end plate, 14 . . . position detector, 14A . . . stator of position detector, 14B . . . rotator of position detector, 15 . . . bearing, τs . . . slot pitch, τcp . . . width of central salient pole, τbp . . . each width of two salient poles formed between U-shaped permanent magnet and outer-periphery permanent magnet, τap . . . total width including the salient pole width τbp and the central salient pole width τcp between adjacent poles

1. A permanent magnet motor comprising:
a permanent magnet rotator of P-pole-implanted type having a ferrite permanent magnet contained in a laminated silicon steel sheet, in which a U-shaped permanent magnet including three parts and an outer-periphery permanent magnet disposed longitudinally in the peripheral direction at the outer periphery of the U-shaped permanent magnet are provided at one pole to generate permanent magnet torque, and two salient poles formed between the U-shaped permanent magnet and the outer-periphery permanent magnet, and one central salient pole formed between the U-shaped permanent magnets of adjacent poles are provided at one pole to generate reluctance torque; and
a stator including a distributed M-phase stator winding and a laminated stator core having Ns slots for storing the stator winding, a ratio of Ns/M/P being a common fraction, wherein:
when a width of the central salient pole is set to τcp and a slot pitch of the stator core is set to τs, the central salient pole width τcp is smaller than the slot pitch τs.

2. The permanent magnet motor according to claim 1, wherein when each width of two salient poles formed between the U-shaped permanent magnet and the outer-periphery permanent magnet is set to τbp, the width τbp is smaller than the slot pitch τs.

3. The permanent magnet motor according to claim 2, wherein a ratio between the width τcp of the central salient pole and the slot pitch τs is set to a relationship of 0.1<τcp/τs<1.0.

4. The permanent magnet motor according to claim 3, wherein the ratio between the width τcp of the central salient pole and the slot pitch τs is set to a relationship of 0.35<τcp/τ<0.7.

5. The permanent magnet motor according to claim 2, wherein at one pole, a ratio between a total width τap including the width τbp of the salient pole formed between the U-shaped permanent magnet and the outer-periphery permanent magnet and the width τcp of the central salient pole, and the slot pitch τs is set to a relationship of 2.1<τap/τs<3.35.

6. The permanent magnet motor according to claim 5, wherein the ratio is set to a relationship of 2.57<τap/τs<2.84.
